(19) United States
(12) Patent Application Publication
(10) Pub. No.: US 2026/0134650 A1
(43) Pub. Date: May 14, 2026

(54) ELECTRONIC DEVICE AND CONTROL METHOD THEREFOR

(71) Applicant: SAMSUNG ELECTRONICS CO., LTD., Suwon-si (KR)

(72) Inventors: Woosung CHUNG, Suwon-si (KR); Kibum SEONG, Suwon-si (KR); Yongseok JANG, Suwon-si (KR)

(73) Assignee: SAMSUNG ELECTRONICS CO., LTD., Suwon-si (KR)

(21) Appl. No.: 19/443,746

(22) Filed: Jan. 8, 2026

Related U.S. Application Data
(63) Continuation of application No. PCT/KR2024/012090, filed on Aug. 14, 2024.

(30) Foreign Application Priority Data
Sep. 19, 2023 (KR) 10-2023-0124649

(51) Int. Cl. G06T 19/20; G06F 3/01; G06T 15/60

(52) U.S. Cl. CPC G06T 19/20; G06F 3/013; G06T 15/60; G06T 2219/2004; G06T 2219/2016

(57) ABSTRACT

An electronic device is disclosed. The electronic device comprises: a mirror display; a sensor; a memory for storing at least one instruction; and one or more processors connected to the mirror display, the sensor and the memory, wherein the one or more processors execute the at least one instruction so as to: identify, on the basis of data acquired through the senor, space information corresponding to a space in which a user is positioned and gaze information of the user; identify the display size and the display position of a virtual object on the basis of the space information and the gaze information of the user; and control the mirror display such that the virtual object is displayed on the basis of the identified display size and the display portion of the virtual object.

### CROSS-REFERENCE TO RELATED APPLICATIONS

This application is a Continuation Application of International Application PCT/KR2024/012090 filed on Aug. 14, 2024, which claims benefit of Korean Patent Application No. 10-2023-0124649, filed on Sep. 19, 2023, at the Korean Intellectual Property Office, the disclosures of which are incorporated herein in their entireties by reference.

### FIELD

The disclosure relates to an electronic apparatus and a control method therefor, and more particularly to an electronic apparatus that includes a mirror display and a control method therefor.

### BACKGROUND ART

With developments in electronic technology, electronic apparatuses of various types are being developed and supplied. Specifically, display apparatuses that are used in various locations such as households, offices, public locations, and the like have been developing continuously for recent several years.

As an example, services of various types may be provided through a mirror display that provides both a mirror function and a display function. For example, the mirror display may become a mirror by reflectivity if an image is not displayed in the display, and operate such that an image is visible to a user by reflectivity if an image is played back.

According to an example, a virtual object may be displayed in a portion of an area even when the mirror display operates in a mirror mode. However, when simply displaying the virtual object, because the real object reflected in the mirror display and the virtual object displayed in the mirror display may have different focal points or lack of three dimensionality, a sense of difference may occur.

### SUMMARY

According to one or more embodiments, an electronic apparatus includes a mirror display, a sensor, memory storing at least one instruction, and one or more processors connected with the mirror display, the sensor, and the memory. The one or more processors, by executing the at least one instruction, cause the electronic apparatus to identify space information corresponding to a space in which a user is positioned and gaze information of the user based on data obtained through the sensor, identify a display size and a display position of a virtual object based on the space information and gaze information of the user, and control the mirror display to display the virtual object based on the identified display size and display position of the virtual object.

According to one or more embodiments, the one or more processors, by executing the at least one instruction, cause the electronic apparatus to identify distance information between the user and the electronic apparatus based on data obtained through the sensor, and identify a display size and a display position of the virtual object based on the space information, gaze information of the user, and distance information between the user and the electronic apparatus.

According to one or more embodiments, the one or more processors, by executing the at least one instruction, cause the electronic apparatus to re-identify, based on at least one of gaze information of the user or distance information between the user and the electronic apparatus being identified as changed, a display shape, a display size, and a display position of the virtual object based on the changed information.

According to one or more embodiments, the one or more processors, by executing the at least one instruction, cause the electronic apparatus to identify distance information between the user and the electronic apparatus based on data obtained through the sensor, identify virtual body data of the user based on data obtained through the sensor, and control the mirror display to display actual body data of the user based on distance information between the user and the electronic apparatus and virtual body data of the user.

According to one or more embodiments, the one or more processors, by executing the at least one instruction, cause the electronic apparatus to identify distance information between the user and the electronic apparatus based on data obtained through the sensor, and control the mirror display to display a virtual object corresponding to the user based on distance information between the user and the electronic apparatus and previous body data of the user.

According to one or more embodiments, the one or more processors, by executing the at least one instruction, cause the electronic apparatus to identify a size and a position of a real object included in a space in which the user is positioned based on data obtained through the sensor, and identify a display size and a display position of a virtual object based on a size and a position of a real object included in a space in which the user is positioned and gaze information of the user.

According to one or more embodiments, the one or more processors, by executing the at least one instruction, cause the electronic apparatus to identify a size and a direction of a shadow of the virtual object based on context information of the electronic apparatus, and a display size and a display position of the virtual object, and control the mirror display to display a shadow of the virtual object based on a size and a direction of a shadow of the virtual object, and the context information may include at least one of time information or light source information.

According to one or more embodiments, the one or more processors, by executing the at least one instruction, cause the electronic apparatus to identify a type of the virtual object based on a type of a real object included in a space in which the user is positioned, and identify a display size and a display position of the virtual object based on a size and a position of the real object.

According to one or more embodiments, the one or more processors, by executing the at least one instruction, cause the electronic apparatus to identify a shadow direction and a ratio of the real object based on a size of a real object included in a space in which the user is positioned and a direction of a light source, and control the mirror display to display a shadow of the virtual object based on a shadow direction and a ratio of the real object.

According to one or more embodiments, the one or more processors, by executing the at least one instruction, cause the electronic apparatus to identify, based on a plurality of users being identified based on data obtained through the sensor, gaze information of each of the plurality of users, identify distance information between each of the plurality of users and the electronic apparatus based on data obtained through the sensor, and identify a display size and a display position of the virtual object based on the space information, gaze information of the plurality of users, and distance information between the plurality of users and the electronic apparatus.

According to one or more embodiments, a control method of an electronic apparatus includes identifying space information corresponding to a space in which a user is positioned and gaze information of the user based on data obtained through the sensor, identifying a display size and a display position of a virtual object based on the space information and gaze information of the user, and displaying the virtual object through a mirror display based on the identified display size and display position of the virtual object.

According to one or more embodiments, a non-transitory computer-readable medium storing computer instructions for an electronic apparatus to perform an operation when executed by a processor of the electronic apparatus, the operation including identifying space information corresponding to a space in which a user is positioned and gaze information of the user based on data obtained through a sensor, identifying a display size and a display position of a virtual object based on the space information and gaze information of the user, and displaying the virtual object through a mirror display based on the identified display size and display position of the virtual object.

### BRIEF DESCRIPTION OF DRAWINGS

Aspects and features of specific embodiments of the disclosure will be made clearer through descriptions described below with reference to the accompanied drawings.

FIG. 1 is a diagram illustrating a use form of a mirror display according to one or more embodiments;

FIG. 2 is a block diagram illustrating a configuration of an electronic apparatus according to an embodiment;

FIG. 3A and FIG. 3B are diagrams illustrating a structure of a mirror display according to one or more embodiments;

FIG. 4 is a diagram illustrating transmittance characteristic information according to an embodiment of the disclosure;

FIG. 5 is a block diagram illustrating in detail a configuration of an electronic apparatus according to one or more embodiments;

FIG. 6 is a diagram illustrating a control method of an electronic apparatus according to one or more embodiments;

FIG. 7A and FIG. 7B are diagrams illustrating a method for displaying a virtual object based on a mirror image according to one or more embodiments;

FIG. 8 is a diagram illustrating a control method of an electronic apparatus according to one or more embodiments;

FIG. 9A and FIG. 9B are diagrams illustrating a virtual object display method according to one or more embodiments;

FIG. 10 is a diagram illustrating a control method of an electronic apparatus according to one or more embodiments;

FIG. 11, FIG. 12, and FIG. 13 are diagrams illustrating a shadow display method of a virtual object according to one or more embodiments;

FIG. 14 is a diagram illustrating a control method of an electronic apparatus according to one or more embodiments;

FIG. 15 is a diagram illustrating a fitness information display method according to one or more embodiments;

FIG. 16 is a diagram illustrating a fitness information display method according to one or more embodiments;

FIG. 17 is a diagram illustrating a virtual object display method for a plurality of users according to one or more embodiments; and

FIG. 18 is a diagram illustrating a virtual object display method for an interior experience according to one or more embodiments.

### DETAILED DESCRIPTION

Terms used in the disclosure will be briefly described, and the disclosure will be described in detail.

The terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) only A, (2) only B, or (3) both A and B.

Expressions such as “1st”, “2nd”, “first”, or “second” used in the disclosure may limit various elements regardless of order and/or importance, and may be used merely to distinguish one element from another element and not limit the relevant element.

When a certain element (e.g., first element) is indicated as being “(operatively or communicatively) coupled with/to” or “connected to” another element (e.g., second element), it may be understood as the certain element being directly coupled with/to the another element, or as being coupled through other element (e.g., third element).

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

In a certain circumstance, the expression “a device configured to . . . ” may mean something that the device “may perform . . . ” together with another device or components. For example, a phrase “a processor configured to (or set up to) perform A, B, and C” may mean a dedicated processor (e.g., an embedded processor) for performing a relevant operation, or a generic-purpose processor (e.g., a central processing unit (CPU) or an application processor) capable of performing the relevant operations by executing one or more software programs stored in a memory device.

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor (not shown).

Meanwhile, the various elements and areas in the drawings have been schematically illustrated. Accordingly, the technical spirit of the disclosure is not limited by relative sizes and distances illustrated in the accompanied drawings.

An embodiment of the disclosure will be described in greater detail below with reference to the accompanied drawings.

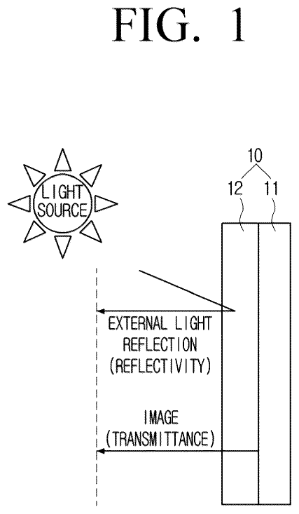

FIG. 1 is a diagram illustrating a use form of a mirror display according to one or more embodiments.

According to an embodiment of the disclosure, an electronic apparatus may be installed in various locations that require a reflective glass (mirror) and implemented as mirror electronic apparatuses of various types capable of transferring information while providing a reflective glass function. Here, a ‘mirror display’ may be a compound word of ‘mirror’ meaning a reflective glass and ‘display’ meaning an operation for visually representing information.

As shown in FIG. 1, a mirror display 10 may be implemented in a form in which a switchable mirror 12 is added to a conventional typical display panel 11.

The display panel 11 may be implemented as a display panel such as a liquid crystal display (LCD) panel, a display panel of organic light emitting diodes (OLED), a liquid crystal on silicon (LCoS), a digital light processing (DLP), and the like.

FIG. 1 is for describing a use form of a typical mirror display 10, and a user may view an image displayed on the display panel 11 which constitute the mirror display 10 transmitted through the switchable mirror 12, and if an image is not simultaneously displayed, the mirror display 10 may be used as reflective glass due to light, that is, an external light source being reflected by the switchable mirror 12, being visible. In addition, a mirror function may be provided in a portion of an area of the mirror display 10, and it may be operated such that a display function is to be provided in another area. For example, a virtual object may be displayed in a portion of an area even when the mirror display is operating in a mirror mode according to an example. In this case, there may be a need to process the virtual object displayed in the mirror display so as to be provided without a sense of difference from a real object that is reflected in the mirror display.

Various embodiments for providing the virtual object displayed in the mirror display without a sense of difference from the real object reflected in the mirror display will be described below.

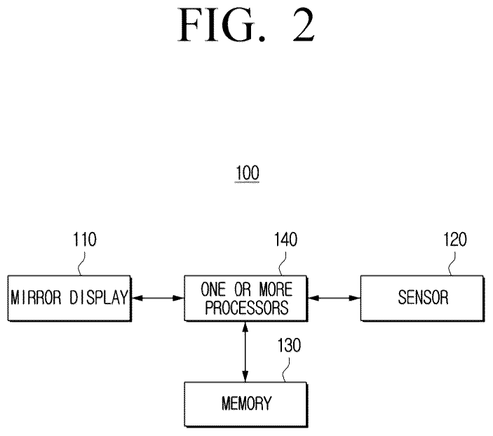

FIG. 2 is a block diagram illustrating a configuration of an electronic apparatus according to an embodiment.

Referring to FIG. 2, an electronic apparatus 100 may include a mirror display 110, a sensor 120, memory 130, and one or more processors 140. According to an example, the electronic apparatus 100 may be implemented as a switchable mirror apparatus that provides the mirror function and the display function.

The mirror display 110 may be implemented as a display including self-emissive devices or a display including non-emissive devices and a backlight. For example, the mirror display 110 may be implemented as a display of various forms such as, for example, and without limitation, a liquid crystal display (LCD), an organic light emitting diode (OLED) display, light emitting diodes (LED), a micro LED, a mini LED, a plasma display panel (PDP), a quantum dot (QD) display, a quantum dot light emitting diodes (QLED), and the like. In the mirror display 110, a driving circuit, which may be implemented in a form of an a-si TFT, a low temperature poly silicon (LTPS) TFT, an organic TFT (OTFT), or the like, a backlight unit, and the like may be included. According to an example, a front surface of the mirror display 110 may be implemented to detect touch inputs of various types due to a touch sensor for detecting a touch operation having a form such as, for example, and without limitation, a touch film, a touch sheet, a touch pad, and the like being disposed. For example, the mirror display 110 may detect touch inputs of various types such as a touch input by a user hand, a touch input by an input device such as a stylus pen, or a touch input by a specific capacitive material. Here, the input device may be implemented as an input device of a pen type that can be referred to in various terms such as, for example, and without limitation, an electronic pen, a stylus pen, an S-pen, and the like. According to an example, the mirror display 110 may be implemented as a flat display, a curved display, a foldable and/or rollable display, and the like.

Meanwhile, the mirror display 110 may be implemented as a display that provides the mirror function and the display function.

For example, the mirror display 110 may be implemented in a form in which the switchable mirror is added to the conventional typical display panel.

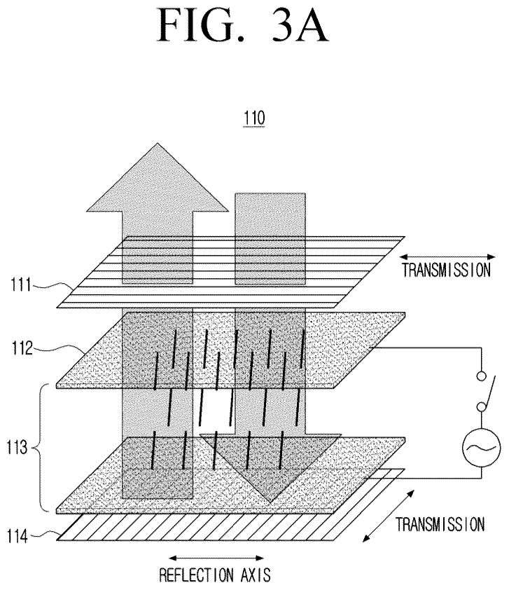

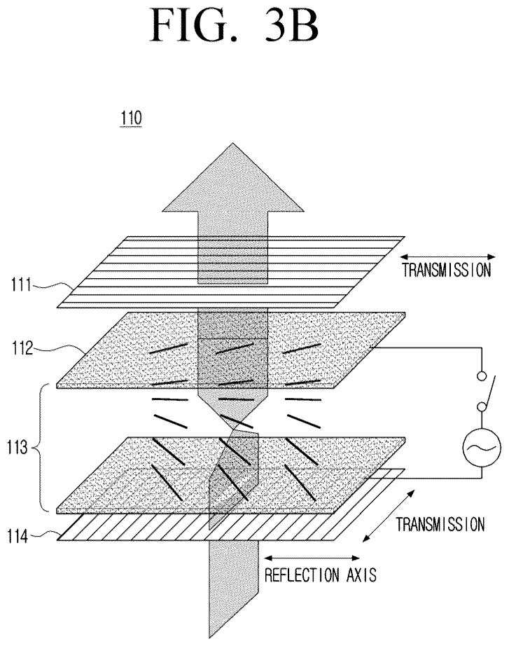

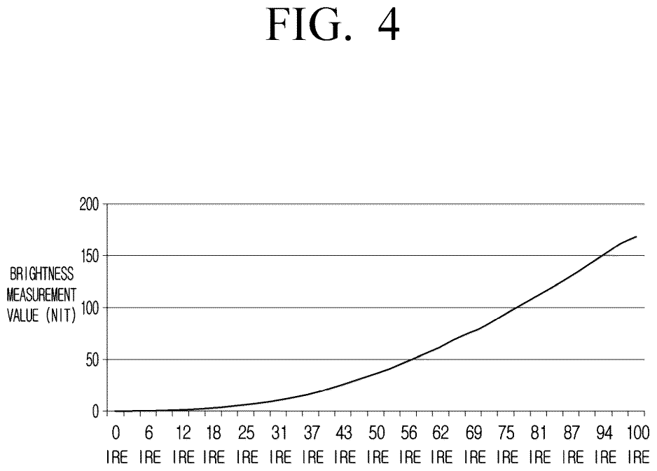

As shown in FIG. 3A and FIG. 3B, a mirror display 110 may be implemented in a form that includes a polarizer 111, an upper glass 112, a lower glass 113, and a reflective polarizer 114. According to an example, a liquid crystal (LC) layer 133 may be formed between the upper glass 112 and the lower glass 113. Liquid crystals (LC) are in a state in-between liquid and crystal and may have a structure in which stick shaped molecules (liquid crystal molecules) are arranged in one direction similarly with solid crystals.

According to an example, the polarizer 111 may be implemented to transmit light that is polarized. According to an example, the upper glass 112 and the lower glass 113 may be implemented with a transparent conductive oxide (TCO) glass, but is not limited thereto.

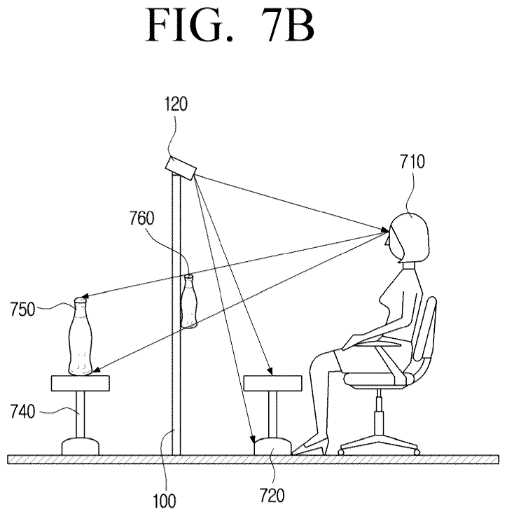

FIG. 7A shows the mirror display 110 when voltage is turned-OFF, and when the voltage is turned-OFF, the liquid crystal molecules may maintain a vertical state, and incident polarized light may be transmitted to the liquid crystal (LC) layer 133 as is and reflected to a reflection axis of the reflective polarizer 114. Accordingly, the mirror display 110 may operate in a mirror mode.

FIG. 7B shows the mirror display 110 when voltage is turned-ON, and when the voltage is turned-OFF, the liquid crystal molecules may maintain a fallen and distorted state, and the incident polarized light may be transmitted to the reflection axis of the reflective polarizer 114 by being rotated 90 degrees. Accordingly, the mirror display 110 may operate in the display mode. According to implementations in addition thereto, a protective film that acts to protect the polarizer, a film that acts to classify light from the polarizer, and the like may be further included.

The sensor 120 may sense whether a user is present or not in front of the electronic apparatus 100, a distance with the user, a speed of approach by the user, a current position of the user, a direction (or angle) toward which the user is positioned, a change in position by the user within a pre-set time range, an action of the user, and the like. In this case, the sensor 120 may be implemented as sensors of various types capable of sensing the user. For example, the sensor 120 may include at least one sensor from among a time of flight (ToF) sensor, an ultrasonic sensor, a RADAR sensor, a photodiode sensor, a proximity sensor, a passive infrared (PIR) sensor, a pinhole sensor, a pinhole camera, an infrared body detection sensor, a CMOS image sensor, a thermal detection sensor, a light sensor, and a motion detection sensor. In an example, if the sensor 120 is implemented as the infrared body detection sensor (e.g., Infrared Ray (IR) time of flight (ToF) method sensor), whether or not the user is present, the speed of approach, current position, change in position, and the like may be sensed based on time in which emitted infrared rays are reflected and received.

In addition, the sensor 120 may further include at least one sensor capable of sensing ambient illuminance, ambient temperature, incident direction of light, and the like. In this case, the sensor 120 may be implemented as an illuminance sensor, a temperature detection sensor, a light amount sensing layer, a camera, and the like. In an example, the illuminance sensor may be disposed inside a glass provided in the mirror display 110, and in this case, a sensing function may be controlled to operate normally inside the glass through an algorithm that compensates transmittance/reflectivity of the glass provided in the mirror display 110.

In addition, the sensor 120 may include sensors of various types such as, for example, and without limitation, the illuminance sensor, the touch sensor, the proximity sensor, an acceleration sensor (or gravity sensor), a geomagnetic sensor, a gyro sensor, a pressure sensor, a position sensor, a distance sensor, and the like.

The memory 130 may store data necessary for various embodiments. The memory 130 may be implemented in a form of memory embedded in an electronic apparatus 100′ according to data storage use, or implemented in a form of a memory attachable to or detachable from the electronic apparatus 100. For example, data for driving the electronic apparatus 100 may be stored in the memory embedded in the electronic apparatus 100, and data for an expansion function of the electronic apparatus 100 may be stored in the memory attachable to or detachable from the electronic apparatus 100. Meanwhile, the memory embedded in the electronic apparatus 100 may be implemented as at least one of a volatile memory (e.g., dynamic RAM (DRAM), static RAM (SRAM), or synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard disk drive (HDD) or solid state drive (SSD)). In addition, the memory attachable to or detachable from the electronic apparatus 100′ may be implemented in a form such as, for example, and without limitation, a memory card (e.g., compact flash (CF), secure digital (SD), micro secure digital (micro-SD), mini secure digital (mini-SD), extreme digital (xD), multi-media card (MMC), etc.), an external memory (e.g., USB memory) connectable to a USB port, or the like.

According to an example, the memory 130 may store at least one instruction for controlling the electronic apparatus or a computer program including instructions.

dAccording to another example, the memory 130 may store an image, in other words, an input image received from an external device (e.g., source device), an external storage medium (e.g., USB), an external server (e.g., WEBHARD), and the like. Alternatively, the memory 130 may store an image obtained through a camera provided in the electronic apparatus 100.

According to still another example, the memory 130 may store various information necessary for image quality processing, for example, information for performing at least one from among noise reduction, detail enhancement, tone mapping, contrast enhancement, color enhancement, or frame rate conversion, an algorithm, an image quality parameter, and the like.

According to an embodiment, the memory 130 may be implemented as a single memory that stores data generated from various operations according to the disclosure. However, according to another embodiment, the memory 130 may be implemented to store data of different types respectively, or to include a plurality of memories storing data generated from different steps respectively.

The memory 130 may store transmittance characteristic information and reflection characteristic information of the mirror display 110.

Here, the transmittance characteristic information of the mirror display 110 may include information about a brightness value according to a grayscale of an image signal determined based on transmittance of the mirror display 110. For example, brightness characteristic information of the mirror display 110 may be a brightness measurement value according to the grayscale of the image signal. In other words, because the mirror display 110 has a fixed transmittance, a brightness value according to the grayscale of the image signal may be obtained when inputting the image signal for each grayscale. In other words, a 0 Institute of Radio Engineers (IRE) (black)—100 IRE (white) image signal (e.g., 0-255 grayscale image in case of an 8 bit image) may be input, a brightness measurement value according to the grayscale of the input image signal may be calculated, and stored in the memory 130. The brightness measurement value according to the grayscale of the image signal described may be referred as a gamma table (or gamma curve), and the above may be calculated by measuring directly by experiments, but it may also be possible to predict and calculate based on the transmittance of the mirror display 110.

Meanwhile, the reflection characteristic information of the mirror display 110 may include at least one of reflectivity information of the mirror display 110 and reflection brightness of the mirror display 110 with respect to external light amount. In an example, the reflection characteristic information may be the reflectivity itself of the mirror display 110. In this case, the reflection brightness according to the external light amount according to an embodiment of the disclosure may be calculated based on the external light amount and reflectivity measured from the sensor 120. In another example, the reflection characteristic information may be information in a form in which the reflection brightness of the mirror display 110 according to the external light amount is pre-measured or pre-calculated. Here, the reflection brightness of the mirror display 110 may be the brightness value generated according to external light being reflected based on the reflectivity of the mirror display 110.

However, the brightness characteristic information and the reflection characteristic information of the mirror display 110 may also be received from an external server or the like. For example, if the brightness characteristic information corresponding to identification information (e.g., manufacturing number, model) of the mirror display 110 is stored in the external server, the electronic apparatus 100 may receive relevant information from the external server.

FIG. 4 is a diagram illustrating transmittance characteristic information of a mirror display according to one or more embodiments.

As shown in FIG. 4, the brightness value may be measured by inputting the 0 IRE (black)-100 IRE (white) image signal in the mirror display 110 that has a fixed transmittance, and the brightness measurement value for each grayscale according thereto, in other words, the transmittance characteristic information may be stored in the memory 130. In addition, the brightness measurement value for each grayscale as described above may be a value predicted by a processor 140 rather than an actual measured value, or received from the outside.

However, depending on circumstance, it may be possible for the memory 130 to store only a basic brightness graph, and the processor 140 to calculate a brightness graph corresponding to transmittance of the mirror display 110 in real-time according to look up table (LUT) or a calculation formula.

In addition, the memory 130 may store various data, programs or applications for driving/controlling the electronic apparatus 100. In addition thereto, the memory 130 may include a user sensing module, a communication control module, a voice recognition module, a motion recognition module, a light reception module, a display control module, an audio control module, an external input control module, a power control module, a voice database (DB), or a motion database (DB).

In the above-described embodiments, various data has been described as being stored in an external memory 130 of the processor 140, but at least a portion from among the above-described data may be stored in a memory inside the processor 140 according to at least one implementation of the electronic apparatus 100 or the processor 140.

The one or more processors 140 may control an operation of the electronic apparatus 100 overall. Specifically, the one or more processors 140 may control an operation of the electronic apparatus overall by being connected with each configuration of the electronic apparatus 100. For example, the one or more processors 140 may control the overall operation of the electronic apparatus 100 by being electrically connected with the mirror display 110 and the memory 130. The one or more processors 140 may be configured as one or a plurality of processors.

The one or more processors 140 may perform, by executing at least one instruction stored in the memory 130, an operation of the electronic apparatus 100 according to various embodiments.

The one or more processors 140 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 140 may control one or a random combination from among other elements of the electronic apparatus, and perform an operation associated with communication or data processing. The one or more processors 140 may execute one or more programs or instructions stored in the memory. For example, the one or more processors may perform, by executing one or more instructions stored in the memory, a method according to one or more embodiments of the disclosure.

When a method according to one or more embodiments of the disclosure includes a plurality of operations, the plurality of operations may be performed by one processor, or performed by a plurality of processors. For example, when a first operation, a second operation, and a third operation are performed by a method according to one or more embodiments, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 140 may be implemented as a single core processor that includes one core, or implemented as one or more multicore processors that include a plurality of cores (e.g., a homogeneous multicore or a heterogeneous multicore). If the one or more processors 140 are implemented as the multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to one or more embodiments of the disclosure, or read and perform a program command for implementing a method according to one or more embodiments of the disclosure due to a whole (or a portion) of the plurality of cores being interconnected.

When a method according to one or more embodiments of the disclosure includes a plurality of operations, the plurality of operations may be performed by one core from among the plurality of cores or performed by the plurality of cores included in the multicore processors. For example, when a first operation, a second operation, and a third operation are performed by a method according to one or more embodiments, the first operation, the second operation, and the third operation may all be performed by a first core included in the multicore processors, or the first operation and the second operation may be performed by the first core included in the multicore processors and the third operation may be performed by a second core included in the multicore processors.

In one or more embodiments of the disclosure, the processor may refer to a system on chip (SoC), a single core processor, or a multicore processor in which the one or more processors and other electronic components are integrated, or a core included in the single core processor or the multicore processors, and the core herein may be implemented as the CPU, the GPU, the APU, the MIC, the DSP, the NPU, the hardware accelerator, the machine learning accelerator, or the like, but is not limited to the embodiments of the disclosure. For convenience of description, the ‘one or more processors 140’ may be designated as the ‘processor 140’.

According to an embodiment, the processor 140 may identify space information corresponding to the space in which the user is positioned and the gaze information of the user based on data obtained through the sensor 120.

For example, the space information may be information about a space in front of the electronic apparatus 100. For example, as information about a space reflected in the mirror display 110, at least one from among information about a size of the space, information about a real object positioned in the space, or information about the user positioned in the space may be included. For example, the information about the real object positioned in the space may include at least one from among position information of the real object, size information, distance information with the user, or distance information between the real object and the electronic apparatus 100. The information about the user positioned in the space may include at least one from among position information of the user, size information, distance information with the user and the electronic apparatus 100, and distance information between the real object and the user.

For example, the gaze information of the user may include information about a gaze position of the user on the mirror display 110. For example, the processor 140 may identify the gaze position of the user by detecting a position of the face of the user from a captured image obtained through a camera and tracking the face position of the user. As a method for detecting a face area, various conventional methods may be used. Specifically, a direct recognition method and a method using statistics may be used. The direct recognition method may involve creating a rule using a skin color of a face image and physical features such as a size of an element or distance between thereto, and comparing, examining, and measuring according to the rule created. The method using statistics may involve detecting a face area according to a pre-trained algorithm. In other words, the method involves digitalizing the input unique features included in the face and comparing and analyzing with a prepared database of a large amount (face and shapes of objects in addition thereto). Specifically, a face area may be detected according to a pre-trained algorithm, and methods such as a multilayer perceptron (MLP) and a support vector machine (SVM) may be used.

The processor 140 may identify a display size and display position of a virtual object based on the space information and the gaze information of the user. For example, the processor 140 may identify the display size and the display position of the virtual object based on the position and gaze information of the user positioned in the space.

The processor 140 may control the mirror display 110 to display the virtual object based on the identified display size and display position of the virtual object. For example, the processor 140 may turn-off backlight of an area in which the mirror function is provided, and turn-on the backlight of the area in which the virtual object is displayed based on local dimming if the mirror display 110 is implemented as liquid crystal elastomer (LCE).

According to an embodiment, the processor 140 may identify distance information between the user and the electronic apparatus 100 based on data obtained through the sensor 120. The processor 140 may identify the display size and display position of the virtual object based on the space information, the gaze information of the user, and the distance information between the user and the electronic apparatus 100.

According to an embodiment, the processor 140 may re-identify, based on at least one of the gaze information of the user or the distance information between the user and the electronic apparatus 100 being identified as changed, a display shape, a display size, and a display position of the virtual object based on changed information. For example, the processor 140 may re-identify, based on the position from which the user gazes the mirror display 110 being changed considering the dynamic movement of the user, the display shape, the display size, and the display position of the virtual object taking into consideration the changed position.

According to an embodiment, the processor 140 may identify virtual body data of the user based on data obtained through the sensor 120. A processor 140 may display actual body data of the user through the mirror display 110 based on the distance information between the user and the electronic apparatus and the virtual body data of the user.

According to an embodiment, the processor 140 display a virtual object corresponding to the user through the mirror display 110 based on the distance information between the user and the electronic apparatus and previous body data of the user.

According to an embodiment, the processor 140 may identify a size and position of a real object included in a space in which the user is positioned based on data obtained through the sensor 120. The processor 140 may identify the display size and display position of the virtual object based on the size and position of the real object included in the space in which the user is positioned, and the gaze information of the user. Accordingly, the real object reflected in the mirror display 110 and the virtual object that is in focus from the gaze of the user may be provided.

According to an embodiment, the processor 140 may identify a size and direction of a shadow of the virtual object based on context information of the electronic apparatus 100, and the display size and display position of the virtual object. According to an example, the context information of the electronic apparatus 100 may include at least one of time information or light source information. The processor 140 may display the shadow of the virtual object through the mirror display 110 based on a size and direction of the shadow of the virtual object. For example, the shadow of the virtual object may be a user experience (UX) effect for adding three dimensionality to the virtual object. Accordingly, various UX effects capable of applying three dimensionality to the virtual object may be applied. For example, various effects such as a matte effect, a 3D effect, and the like may be applied to add three dimensionality to the virtual object.

According to an embodiment, the processor 140 may identify, based on a plurality of users being identified based on data obtained through the sensor 120, gaze information of each of the plurality of users. The processor 140 may identify distance information between each of the plurality of users and the electronic apparatus 100 based on data obtained through the sensor 120. The processor 140 may identify the display size and display position of the virtual object based on the space information, the gaze information of the plurality of users, and the distance information between the plurality of users and the electronic apparatus 100.

According to an embodiment, the processor 140 may identify a type of the virtual object based on a type of the real object included in the space in which the user is positioned, and identify the display size and display position of the virtual object based on the size and position of the real object.

According to an embodiment, the processor 140 may identify the type of the virtual object based on preference of the user and the type of the real object. For example, the processor 140 may identify the virtual object as a vase containing a flower by taking into consideration the preference of the user if the type of the real object is a table.

According to an embodiment, the processor 140 may identify the type of the virtual object based on context of the electronic apparatus 100 and the type of the real object. For example, the processor 140 may identify, based on the current time being a time when the user is able to rest and the type of the real object being a cat, the virtual object for a hunting game to be played with the cat.

According to an embodiment, the processor 140 may identify a direction and ratio of a shadow of the real object based on the size of the real object and direction of a light source included in the space in which the user is positioned, and display the shadow of the virtual object through the mirror display 110 based on the direction and ratio of the shadow of the real object.

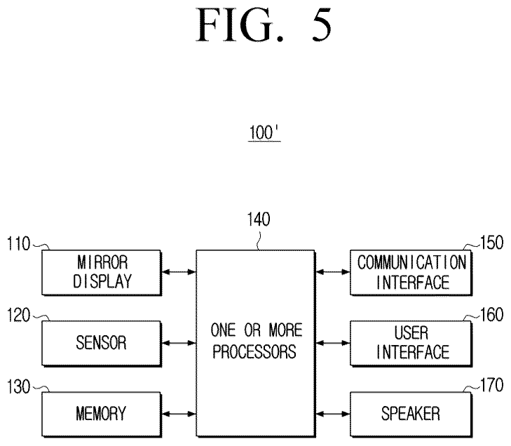

FIG. 5 is a block diagram illustrating in detail a configuration of an electronic apparatus according to one or more embodiments.

Referring to FIG. 5, an electronic apparatus 100′ may include the mirror display 110, the sensor 120, the memory 130, the one or more processors 140, a communication interface 150, a user interface 160, and a speaker 170. Detailed descriptions of configurations that overlap with the configurations shown in FIG. 2 from among the configurations shown in FIG. 5 will be omitted.

The communication interface 150 may be implemented as various interfaces according to an implementation of the electronic apparatus 100′. For example, the communication interface 150 may perform communication with an external device, an external storage medium (e.g., USB memory), an external server (e.g., WEBHARD), and the like through communication methods such as, for example, and without limitation, Bluetooth, an AP based Wi-Fi (e.g., wireless LAN network), Zigbee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like. According to an example, the communication interface 150 may perform communication with other electronic apparatuses, external servers and/or remote control devices, and the like.

The user interface 160 may be implemented with a device such as a button, a touch pad, a mouse and a keyboard, or implemented as a touch screen capable of performing the above-described display function and the operation input function together therewith.

The speaker 170 may be a configuration for outputting not only various audio data, but also various notification sounds, voice messages, and the like. The processor 140 may control the speaker 170 to output feedback or various notifications in audio form according to the various embodiments of the disclosure.

In addition thereto, the electronic apparatus 100′ may further include a microphone according to the implementation.

The microphone may be a configuration for receive input of a user voice or other sounds and converting to audio data. However, according to another embodiment, the electronic apparatus 100′ may receive the user voice input through an external device through the communication interface 150.

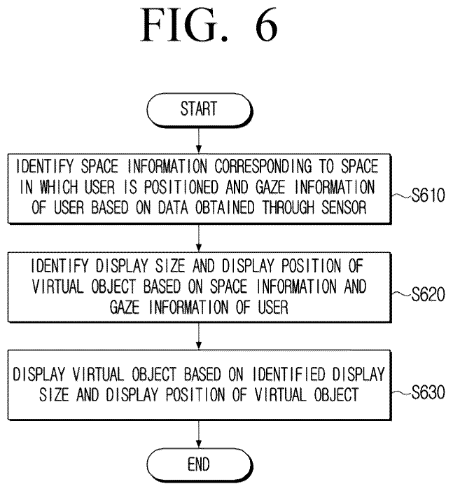

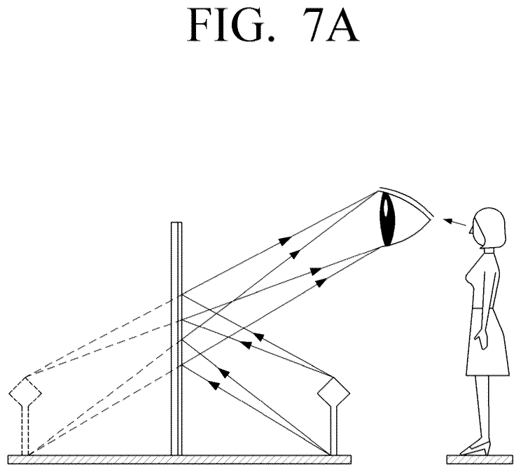

FIG. 6 is a diagram illustrating a control method of an electronic apparatus according to one or more embodiments.

Referring to FIG. 6, the electronic apparatus 100 may identify the space information corresponding to the space in which the user is positioned and the gaze information of the user based on data obtained through the sensor 120 (S610).

Then, the electronic apparatus 100 may identify the display size and display position of the virtual object based on the space information and the gaze information of the user (S620).

Then, the electronic apparatus 100 may control the mirror display 110 to display the virtual object based on the identified display size and display position of the virtual object (S630).

According to an embodiment, the electronic apparatus 100 may identify the size and position of the real object included in the space in which the user is positioned based on data obtained through the sensor 120. Then, the electronic apparatus 100 may identify the display size and display position of the virtual object based on the size and position of the real object included in the space in which the user is positioned, and the gaze information of the user.

According to an embodiment, the electronic apparatus 100 may identify the type of the virtual object based on the type of the real object included in the space in which the user is positioned. In addition, the electronic apparatus 100 may identify the display size and display position of the virtual object based on the size and position of the real object.

According to an embodiment, the processor 140 may identify the display size and display position of the virtual object based on the space information and the gaze information of the user. For example, the processor 140 may identify the display size and display position of the virtual object based on the position and the gaze information of the user positioned in the space. The processor 140 may control the mirror display 110 to display the virtual object based on the identified display size and display position of the virtual object.

According to an embodiment, the processor 140 may image process an image of the virtual object such that the virtual object is displayed without a sense of difference from the real object reflected in the mirror display 110 based on the transmittance characteristic information and the reflection characteristic information of the mirror display 110. For example, the processor 140 may adjust a pixel value, a brightness value, and the like of the image of the virtual object such that the virtual object is displayed without a sense of difference from the real object reflected in the mirror display 110.

FIG. 7A and FIG. 7B are diagrams illustrating a method for displaying a virtual object based on a mirror image according to one or more embodiments.

According to an embodiment, the electronic apparatus 100 may display the virtual object based on the mirror image principle. The mirror image may refer to an image of an object reflected on a reflective glass. The reflective glass images on a flat reflective glass may appear the same with each other, but is a reflection copy of the object that is opposite of a direction that is vertical to the surface of the reflective glass. The above may be an optical effect which can occur due to a reflection of a material such as the reflective glass or water.

Referring to FIG. 7A, because the eyes of the user fail to perceive an image reflected on a surface of the reflective glass and sense the same as if light is delivered straight from a back surface of the reflective glass, the image has to be drawn at a back side of the reflective glass. In this case, the image by the flat reflective glass may be the same in size as with a real object, may appear as if the left and right thereof are reversed, and a distance to the real object may be the same as a distance to the image on the reflective glass.

Referring to FIG. 7B, it may be assumed that a table which is a real object 720 is positioned in an actual space in which a user 720 is positioned. The electronic apparatus 100 may identify a gaze position of the user 710, a distance with the user 710, a size, position, distance, and the like of a real object 720 based on data obtained through the sensor 120. For example, as shown in FIG. 7B, if the actual object is a table 720 and the virtual object is a virtual drink, a display size and position of a virtual object 760 to be displayed on the mirror display 110 may be identified using the law of perspective based on a mirror image 740 and a virtual object 750 of the actual object 720, and display so as to match an angle of view by the user 710 on the electronic apparatus 100. Accordingly, the user may be able to recognize an image which appears as if the virtual drink which is the virtual object 760 is placed in the mirror image of the table which is the real object 720.

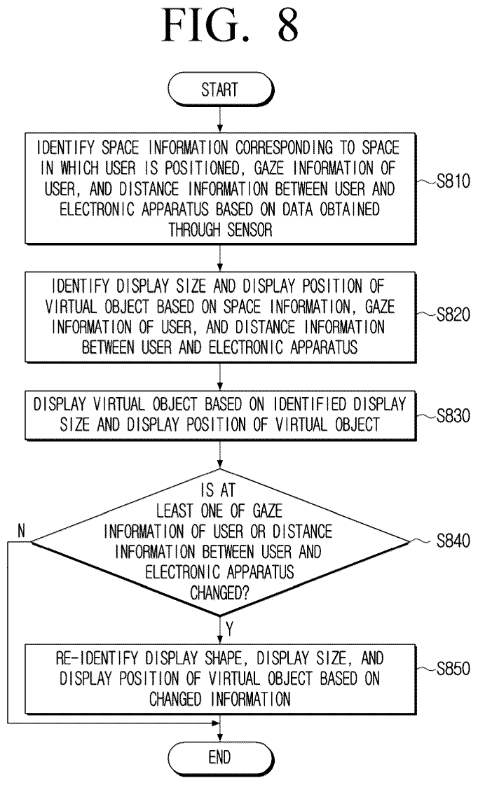

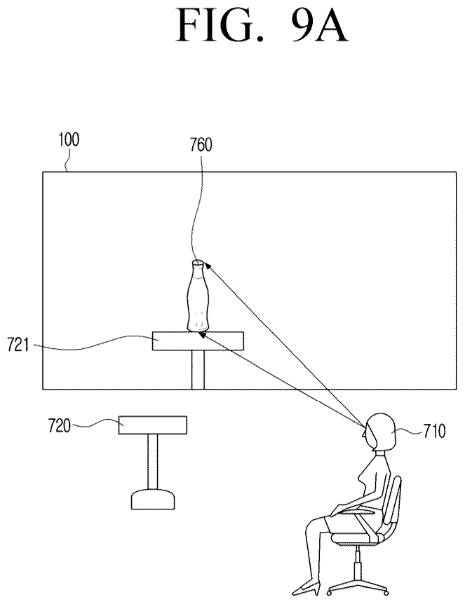

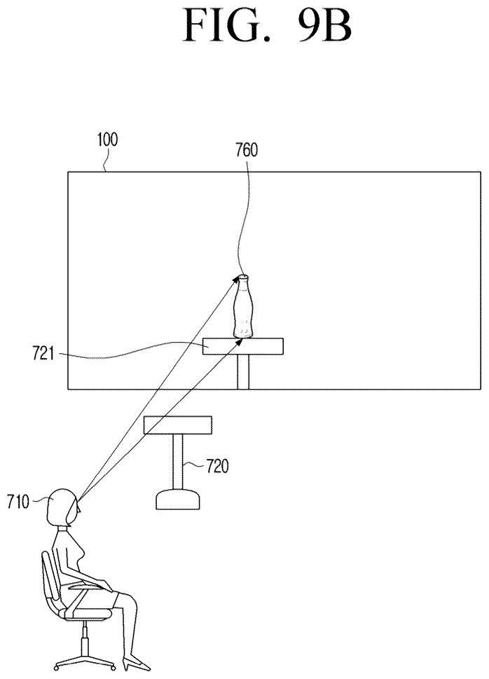

FIG. 8 is a diagram illustrating a control method of an electronic apparatus according to one or more embodiments.

Referring to FIG. 8, the electronic apparatus 100 may identify the space information corresponding to the space in which the user is positioned, the gaze information of the user, and the distance information between the user and the electronic apparatus 100 based on data obtained through the sensor 120 (S810).

Then, the electronic apparatus 100 may identify the display size and display position of the virtual object based on the space information, the gaze information of the user, and the distance information between the user and the electronic apparatus 100 (S820).

Then, the electronic apparatus 100 may control the mirror display 110 to display the virtual object based on the identified display size and display position of the virtual object (S830).

Then, the electronic apparatus 100 may re-identify, based on at least one of the gaze information of the user or the distance information between the user and the electronic apparatus 100 being identified as changed (S840:Y), the display shape, the display size, and the display position of the virtual object based on the changed information (S850).

FIG. 9A and FIG. 9B are diagrams illustrating a virtual object display method according to one or more embodiments.

According to an embodiment, if a distance between the user and the electronic apparatus 100 is changed, or if a direction to which the user is gazing at the electronic apparatus 100 is changed, the display shape, the display size, and the display position of the virtual object may be re-identified based on at least one of the changed distance or direction.

According to an example, as shown in FIG. 9A, if a gaze direction of the user 710 is toward a right direction based on the electronic apparatus 100 and a distance with the electronic apparatus 100 is a first distance, the virtual object may be displayed by identifying the display shape, the display size, and the display position of the virtual object 760 based on the relevant gaze direction, and distance, and the position and distance of the real object 720. For example, the electronic apparatus 100 may identify the display shape, the display size, and the display position of the virtual object 760 based on the method as shown in FIG. 7A and FIG. 7B. Accordingly, the user may be able to perceive an image that is as if a virtual object, which is the virtual object 760, is placed in the mirror image of the table, which is the real object 720.

According to an example, as shown in FIG. 9B, if a gaze direction of the user is toward a left direction based on the electronic apparatus 100 and a distance between the user and the electronic apparatus 100 is changed to a second distance, the virtual object may be displayed by re-identifying the display shape, the display size, and the display position of the virtual object 760 based on the changed direction and distance of the gaze direction, and the position and distance of the real object 720. For example, the electronic apparatus 100 may re-identify the display shape, the display size, and the display position of the virtual object 760 based on the method as shown in FIG. 7A and FIG. 7B. Accordingly, the user may be able to perceive an image that is as if a virtual drink, which is the virtual object 760, is placed in the mirror image of the table, which is the real object 720.

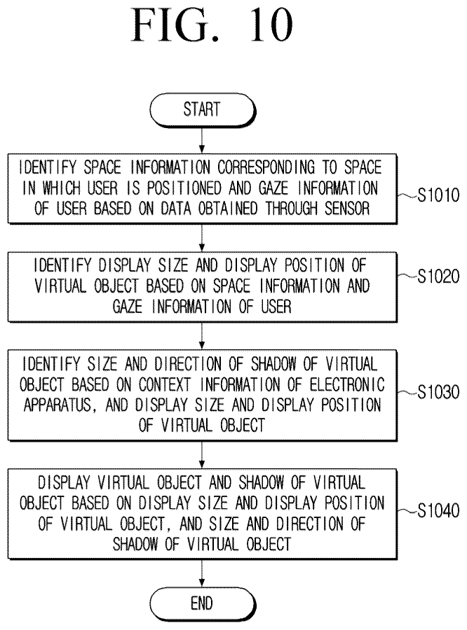

FIG. 10 is a diagram illustrating a control method of an electronic apparatus according to one or more embodiments.

Referring to FIG. 10, the electronic apparatus 100 may identify the space information corresponding to a space in which the user is positioned and the gaze information of the user based on data obtained through the sensor 120 (S1010).

Then, the electronic apparatus 100 may identify the display size and display position of the virtual object based on the space information and the gaze information of the user (S1020).

Then, the electronic apparatus 100 may identify the size and direction of the shadow of the virtual object based on the context information and the display size and display position of the virtual object (S1030). According to an example, the context information may include at least one of time information or light source information. Here, a light source may include not only a natural light source such as the sun, but also an artificial light source of various types that emits light such as a lamp. However, the above is not limited thereto, and virtual light source information selected by the user may also be included. Here, the time information may include not only standard time information, but also virtual time information selected by the user.

Then, the electronic apparatus 100 may control the mirror display 110 to display the virtual object and the shadow of the virtual object based on the display size and display position of the virtual object, and the size and direction of the shadow of the virtual object (S1040).

According to an example, the electronic apparatus 100 may identify a direction and ratio of a shadow of the real object based on the size of the real object included in the space in which the user is positioned and the direction of the light source. Then, the electronic apparatus 100 may display the shadow of the virtual object based on the shadow direction and ration of the real object.

According to an example, the electronic apparatus 100 may identify a size and direction of a shadow of a virtual object of a different type based on a type, intensity, and the like of the light source. For example, the electronic apparatus 100 may identify contrast, color, and the like of the shadow of the virtual object differently according to the type of the light source. According to an example, the electronic apparatus 100 may perform image processing such that the shadow of the virtual object is represented without a sense of difference from the shadow of the real object based on the transmittance characteristic information and the reflection characteristic information of the mirror display 110.

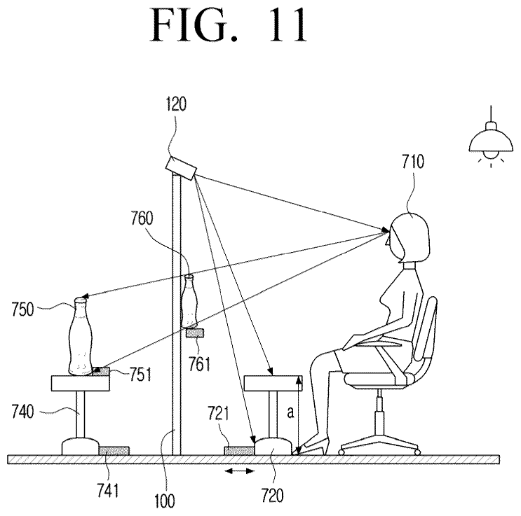

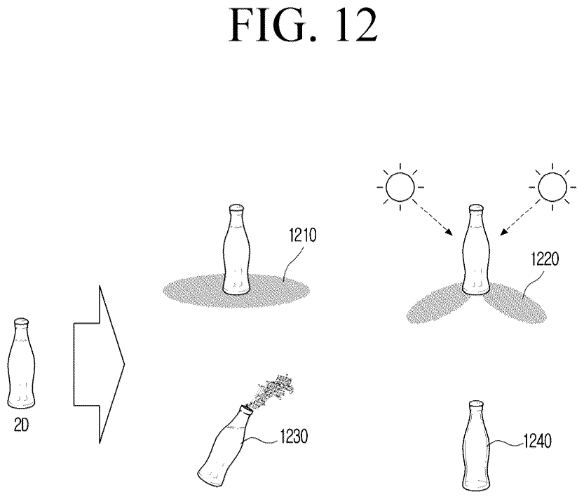

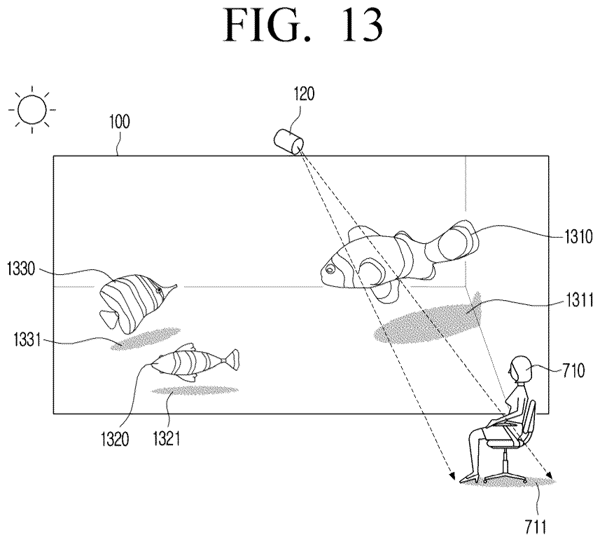

FIG. 11, FIG. 12, and FIG. 13 are diagrams illustrating a shadow display method of a virtual object according to one or more embodiments.

Referring to FIG. 11, the electronic apparatus 100 may identify a position and size (a) of the real object 720 in front of the electronic apparatus 100 based on data obtained through the sensor 120, and identify a direction, size, and ratio of a shadow 721 of the real object 720 by the light source.

The electronic apparatus 100 may identify a size of a shadow 741 of the mirror image 740 of the real object, and identify a shadow size 751 of the virtual object 750 based on the size of the shadow 741 of the mirror image 740 of the real object.

The electronic apparatus 100 may identify a shadow size of the virtual object 760 to be displayed on the mirror display 110 using the law of perspective based on the shadow size 751 of the virtual object 750, and display the virtual object 760 and a corresponding shadow 761 on the mirror display 110. According to an example, the electronic apparatus 100 may identify the shadow size of the virtual object based on a principle of “size of virtual object:shadow size of virtual object=size of real object:shadow size of real object”. Here, the size of the virtual object may be identified using the law of perspective based on the gaze of the user 710.

Referring to FIG. 12, the electronic apparatus 100 may implement various three dimensional effects based on an environment of a virtual space.

According to an example, as shown in FIG. 12, a three dimensional effect (3D effect) may be implemented by displaying a matte shadow together with the virtual object displayed in the mirror display 110 (1210).

According to an example, as shown in FIG. 12, the 3D effect may be implemented by displaying a shadow according to a direction of the light source together with the virtual object displayed in the mirror display 110 (1220). For example, the 3D effect may be implemented by changing the direction of the shadow of the virtual object based on the direction of the light source according to time information.

According to an example, as shown in FIG. 12, the 3D effect may be implemented by providing a moving image effect together with the virtual object displayed in the mirror display 110 (1230).

According to an example, as shown in FIG. 12, the virtual object displayed in the mirror display 110 may be implement with the 3D effect in a transparent 3D shape (1240).

Referring to FIG. 13, the electronic apparatus 100 may provide an ambient mode through the mirror display 110.

According to an example, as shown in FIG. 13, a direction of a shadow 711 of the user 710 may be identified based on data obtained through the sensor 120, and the ambient mode may be provided by identifying directions of shadows 1311, 1321, and 1331 of virtual objects 1310, 1320, and 1330 based on the direction of the shadow 711 of the user 710. For example, as shown in FIG. 13, an aquarium mode including a plurality of virtual objects 1310, 1320, and 1330 may be provided as the ambient mode.

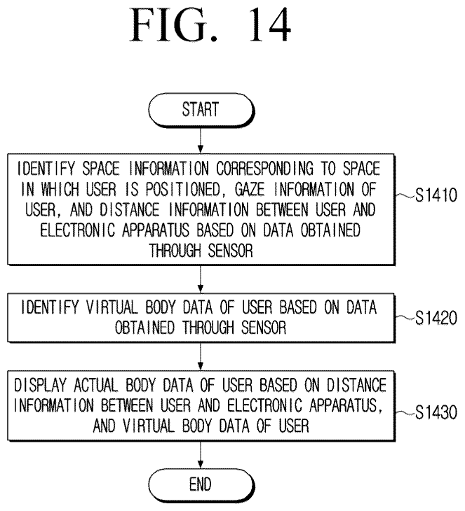

FIG. 14 is a diagram illustrating a control method of an electronic apparatus according to one or more embodiments.

Referring to FIG. 14, the electronic apparatus 100 may identify the space information corresponding to the space in which the user is positioned, the gaze information of the user, and the distance information between the user and the electronic apparatus 100 based on data obtained through the sensor 120 (S1410).

Then, the electronic apparatus 100 may identify virtual body data of the user based on data obtained through the sensor 120 (S1420). For example, the virtual body data of the user may be body data obtained through the sensor 120. For example, if an image that captured the user through the sensor 120 is obtained, the virtual body data may be the body data of the user include in the captured image.

Then, the electronic apparatus 100 may control the mirror display 110 to display actual body data of the user based on the distance information between the user and the electronic apparatus 100 and the virtual body data of the user. For example, the electronic apparatus 100 may identify the actual body data of the user based on the distance information between the user and the electronic apparatus 100 and the virtual body data of the user. For example, the distance information between the user and the electronic apparatus 100 may be obtained through a distance sensor.

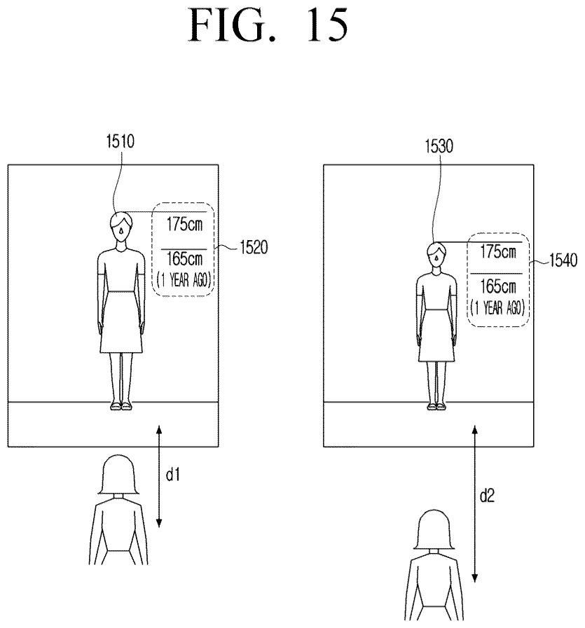

FIG. 15 is a diagram illustrating a fitness information display method according to one or more embodiments.

Referring to FIG. 15, the electronic apparatus 100 may display the body data of the user in a size corresponding to the corresponding display position based on a distance with the user and position of the user obtained through the sensor.

For example, the electronic apparatus 100 may identify, if a distance with the user is d1, a size and position 1510 of the user reflected in the mirror display 110, and display body data 1520 of the user based on the size and position 1510 of the user.

For example, the electronic apparatus 100 may identify, if a distance with the user is d2, a size and position 1530 of the user reflected in the mirror display 110, and identify body data 1540 of the user based on the size and position 1530 of the user.

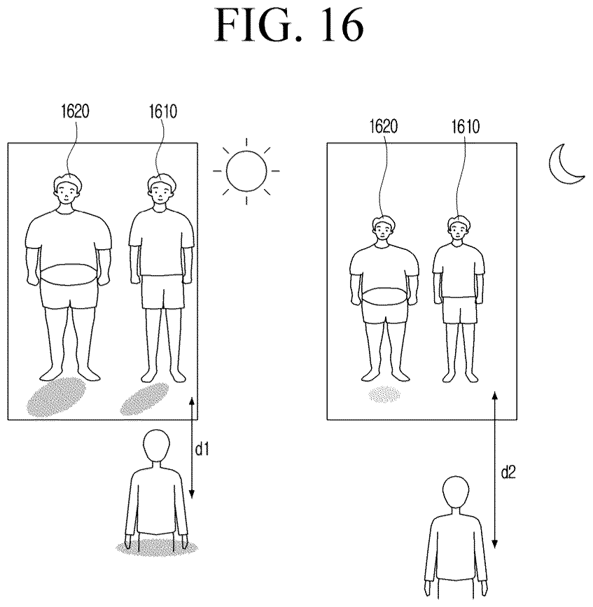

FIG. 16 is a diagram illustrating a fitness information display method according to one or more embodiments.

According to an embodiment, the electronic apparatus 100 may identify the space information corresponding to the space in which the user is positioned, the gaze information of the user, and the distance information between the user and the electronic apparatus 100 based on data obtained through the sensor 120. Then, the electronic apparatus 100 may identify a virtual object corresponding to the user based on the distance information between the user and the electronic apparatus 100, and previous body data of the user. Then, the electronic apparatus 100 may control the mirror display 110 to display the virtual object corresponding to the user based on the space information, the gaze information of the user, and the distance information between the user and the electronic apparatus 100.

According to an example, referring to FIG. 16, the electronic apparatus 100 may identify a size of the user and a shadow size in front of the mirror display 110 based on data obtained through the sensor 120, and display a virtual user 1620 corresponding to the previous body data of the user based on a gaze position of the user. In this case, the electronic apparatus 100 may display the virtual user 1620 corresponding to the previous body data based on the distance d1 between the user and the electronic apparatus 100.

According to an example, the electronic apparatus 100 may display, based on a distance between the electronic apparatus 100 and the user being changed (d1>d2), the virtual user 1620 corresponding to the previous body data based on a changed distance d2 with the user. Accordingly, the user may compare a current image 1610 reflected in the mirror and a virtual image 160 corresponding to the previous body data.

According to an example, the electronic apparatus 100 may change, based on the surrounding environment being changed, the background image of the mirror display 110 and display the same based on the changed surrounding environment. For example, the virtual user 1620 and the corresponding shadow may be displayed together in a bright background during daytime, and the virtual user 1620 may be displayed in a dark background during nighttime.

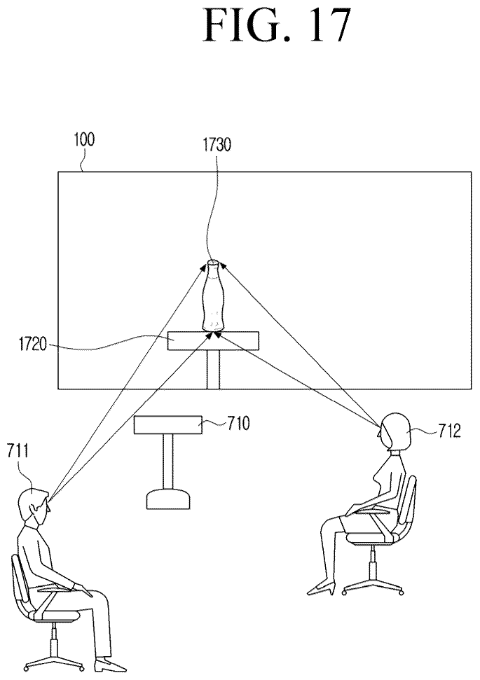

FIG. 17 is a diagram illustrating a virtual object display method for a plurality of users according to one or more embodiments.

According to an embodiment, the electronic apparatus 100 may identify, based on a plurality of users being identified based on data obtained through the sensor 120, gaze information of each of the plurality of users. In addition, the electronic apparatus 100 may identify distance information between each of the plurality of users and the electronic apparatus 100 based on data obtained through the sensor 120. Then, the electronic apparatus 100 may identify the display size and display position of the virtual object based on the space information, the gaze information of the plurality of users, and the distance information between the plurality of users and the electronic apparatus 100. Then, the electronic apparatus 100 may control the mirror display 110 to display the virtual object based on the identified display size and display position of the virtual object.

According to an example, referring to FIG. 17, the electronic apparatus 100 may identify, based on a plurality of users 711 and 712 being identified in front of the mirror display 110, a position of a mirror image 1720 of a real object 1710 based on gaze information of the plurality of users 711 and 712 and a position of the real object 1710, and display a virtual object 1730 at a position which appears as same as possible to the plurality of users 711 and 712 as a mirror image based on a position of the mirror image 1720 of the real object 1710.

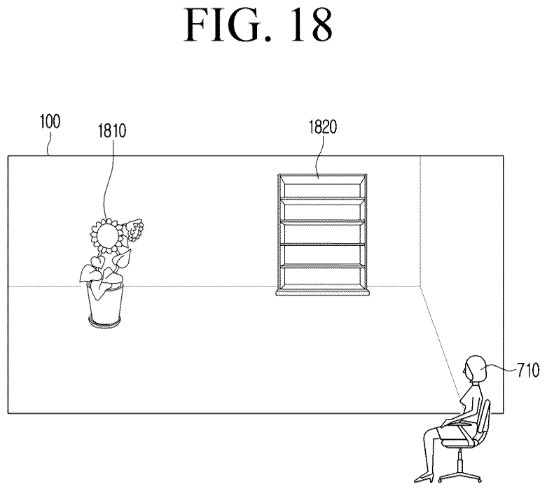

FIG. 18 is a diagram illustrating a virtual object display method for an interior experience according to one or more embodiments.

*Referring to FIG. 18, the electronic apparatus 100 may display a virtual interior object for an interior experience on the mirror display 110.

According to an example, the electronic apparatus 100 may display virtual interior objects 1810 and 1820 for the interior experience on the mirror display 110 based on at least one from among a user command, a user preference, and a type of the real object. For example, the electronic apparatus 100 may display the virtual interior objects 1810 and 1820 based on preference information of the user. For example, the electronic apparatus 100 may display the virtual interior objects 1810 and 1820 that suit the real object based on a type of a real interior object obtained through the sensor. For example, the virtual interior object may include various interior decorations such as furniture, an aquarium, and plants.

According to one or more embodiments, the electronic apparatus 100 may identify a front situation of the mirror display 110 based on data obtained through the sensor 120, and recommend content corresponding to the front situation.

For example, the electronic apparatus 100 may automatically recommend content by checking the physique of the user after sensing the distance of the user. For example, if the user is determined as a young child, cartoons and programs for young children and the like may be automatically displayed, and if the user is determined as a pet, a program for pets may be automatically displayed. In this case, the electronic apparatus 100 may display recommended content in an appropriate size at an appropriate position based on a distance with the real object, a position and size of the real object, and the like.

According to various embodiments of the disclosure as described above, a virtual object without a sense of difference with the actual object reflected on the mirror display may be provided through the mirror display based on the gaze, position, space information, and the like of the user. In addition, an AR based virtual object may be provided to have three dimensionality on the mirror display. In addition, the virtual object may be provided realistically using a 3D image technology.

Meanwhile, the methods according to the various embodiments of the disclosure described above may be implemented with only a software upgrade, or a hardware upgrade for the electronic apparatus of the related art.

In addition, the various embodiments of the disclosure described above may be performed through an embedded server provided in the electronic apparatus, or an external server of the electronic apparatus.

Meanwhile, according to an embodiment of the disclosure, the various embodiments described above may be implemented with software including instructions stored in a machine-readable storage media (e.g., computer). The machine may call stored instructions from a storage medium, and as an apparatus operable according to the called instructions, may include an electronic apparatus (e.g., electronic apparatus (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, each of the elements (e.g., a module or a program) according to the various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

1. An electronic apparatus, comprising:
a mirror display;
a sensor;
memory storing at least one instruction; and
one or more processors connected with the mirror display, the sensor, and the memory,
wherein the one or more processors, by executing the at least one instruction, cause the electronic apparatus to:
identify space information corresponding to a space in which a user is positioned and gaze information of the user based on data obtained through the sensor,
identify a display size and a display position of a virtual object based on the space information and gaze information of the user, and
control the mirror display to display the virtual object based on the display size and the display position of the virtual object.

2. The electronic apparatus of claim 1,
wherein the one or more processors, by executing the at least one instruction, further cause the electronic apparatus to:
identify distance information between the user and the electronic apparatus based on the data obtained through the sensor, and
wherein the identifying the display size and the display position of the virtual object is further based on the distance information between the user and the electronic apparatus.

3. The electronic apparatus of claim 2,
wherein the display size is a first display size, the display position is a first display position,
wherein the one or more processors, by executing the at least one instruction, further cause the electronic apparatus to:
re-identify, based on at least one of the gaze information of the user or the distance information between the user and the electronic apparatus being identified as changed, a display shape, a second display size, and a second display position of the virtual object.

4. The electronic apparatus of claim 2,
wherein the one or more processors, by executing the at least one instruction, further cause the electronic apparatus to:
identify virtual body data of the user based on the data obtained through the sensor, and
control the mirror display to display actual body data of the user based on the distance information between the user and the electronic apparatus and based on the virtual body data of the user.

5. The electronic apparatus of claim 2,
wherein the one or more processors, by executing the at least one instruction, further cause the electronic apparatus to:
control the mirror display to display a virtual object corresponding to the user based on the distance information between the user and the electronic apparatus and based on previous body data of the user.

6. The electronic apparatus of claim 1,
wherein the one or more processors, by executing the at least one instruction, further cause the electronic apparatus to:
identify a size and a position of a real object in the space in which the user is positioned based on the data obtained through the sensor, and
wherein the identifying the display size and the display position of the virtual object is further based on the size and the position of the real object and the gaze information of the user.

7. The electronic apparatus of claim 1,
wherein the one or more processors, by executing the at least one instruction, further cause the electronic apparatus to:
identify a size and a direction of a shadow of the virtual object based on context information of the electronic apparatus, and the display size and the display position of the virtual object, and
control the mirror display to display the shadow of the virtual object based on the size and the direction of the shadow of the virtual object,
wherein the context information comprises at least one of time information or light source information.

8. The electronic apparatus of claim 1,
wherein the one or more processors, by executing the at least one instruction, further cause the electronic apparatus to:
identify a type of the virtual object based on a type of a real object in the space in which the user is positioned, and
wherein the identifying the display size and the display position of the virtual object is further based on a size and a position of the real object.

9. The electronic apparatus of claim 8,
wherein the one or more processors, by executing the at least one instruction, further cause the electronic apparatus to:
identify a shadow direction and a ratio of the real object based on a size of a real object in the space in which the user is positioned and a direction of a light source, and
control the mirror display to display a shadow of the virtual object based on the shadow direction and the ratio of the real object.

10. The electronic apparatus of claim 1,
wherein the one or more processors, by executing the at least one instruction, further cause the electronic apparatus to:
identify, based on a plurality of users being identified based on data obtained through the sensor, gaze information of the plurality of users,
identify distance information between the plurality of users and the electronic apparatus based on the data obtained through the sensor, and
identify the display size and the display position of the virtual object based on the space information, the gaze information of the plurality of users, and the distance information between the plurality of users and the electronic apparatus.

11. A control method of an electronic apparatus, the method comprising:
identifying space information corresponding to a space in which a user is positioned and gaze information of the user based on data obtained through the sensor;
identifying a display size and a display position of a virtual object based on the space information and gaze information of the user; and
displaying the virtual object through a mirror display based on the display size and the display position of the virtual object.

12. The method of claim 11,
wherein the identifying the display size and the display position of a virtual object further comprises:
identifying distance information between the user and the electronic apparatus based on the data obtained through the sensor; and
identifying the display size and the display position of the virtual object based on the space information, the gaze information of the user, and distance information between the user and the electronic apparatus.

13. The method of claim 12, wherein the display size is a first display size, the display position is a first display position, the method further comprising:
re-identifying, based on at least one of the gaze information of the user or the distance information between the user and the electronic apparatus being identified as changed, a display shape, a second display size, and a second display position of the virtual object.

14. The method of claim 12, further comprising:
identifying virtual body data of the user based on the data obtained through the sensor; and
displaying actual body data of the user through the mirror display based on the distance information between the user and the electronic apparatus and based on the virtual body data of the user.

15. The method of claim 12, further comprising:
controlling the mirror display to display a virtual object corresponding to the user based on the distance information between the user and the electronic apparatus and based on previous body data of the user.

16. The method of claim 11, wherein the identifying the display size and the display position of the virtual object comprises:
identifying the display size and the display position of the virtual object is further based on the size and the position of the real object and the gaze information of the user.

17. The method of claim 11, further comprising:
identifying a size and a direction of a shadow of the virtual object based on context information of the electronic apparatus, and the display size and the display position of the virtual object, and
controlling the mirror display to display the shadow of the virtual object based on the size and the direction of the shadow of the virtual object,
wherein the context information comprises at least one of time information or light source information.

18. The method of claim 12, further comprising:
identifying a type of the virtual object based on a type of a real object in the space in which the user is positioned, and
wherein the identifying the display size and the display position of the virtual object is further based on a size and a position of the real object.

19. The method of claim 18, further comprising:
identifying a shadow direction and a ratio of the real object based on a size of a real object in the space in which the user is positioned and a direction of a light source, and
controlling the mirror display to display a shadow of the virtual object based on the shadow direction and the ratio of the real object.

20. A non-transitory computer-readable medium storing computer instructions for an electronic apparatus to perform an operation when executed by a processor of the electronic apparatus, the operation comprising:
identifying space information corresponding to a space in which a user is positioned and gaze information of the user based on data obtained through a sensor;
identifying a display size and a display position of a virtual object based on the space information and gaze information of the user; and
displaying the virtual object through a mirror display based on the display size and the display position of the virtual object.
